(19) United States
(12) Patent Application Publication
(10) Pub. No.: US 2026/0292470 A1
(43) Pub. Date: Sep. 24, 2026

(54) NETWORK SERVICE SEGREGATION AND PROFILING

(71) Applicant: RAKUTEN MOBILE, INC., Tokyo (JP)

(72) Inventors: Saurabh VERMA, Tokyo (JP); Masahiko NANRI, Tokyo (JP)

(73) Assignee: RAKUTEN MOBILE, INC., Tokyo (JP)

(21) Appl. No.: 19/082,361

(22) Filed: Mar. 18, 2025

(51) Int. Cl. H04W 8/08; H04W 60/00

(52) U.S. Cl. CPC H04W 8/08; H04W 60/00

(57) ABSTRACT

Example embodiments of the present disclosure relate to network service segregation and profiling. According to example embodiments, a method may include receiving, by an Access and Mobility Management Function (AMF), a message from a user equipment (UE) comprising a request for service access; generating, by the AMF based on the request, a service set definition comprising a service set cell group; and forwarding, by the AMF, the service set definition to a Session Management Function (SMF).

### TECHNICAL FIELD

The present disclosure relates to network service segregation and profiling.

### BACKGROUND

The information disclosed in this background section is only for the enhancement of understanding of the general background of the disclosure and should not be taken as an acknowledgement or any form of suggestion that this information forms the prior art already known to a person skilled in the art.

A private 5G network is a dedicated, local wireless network that provides 5G connectivity tailored to a specific organization's needs, offering enhanced security, control, and customization compared to public 5G networks. Further, a private 5G network has the capability to limit the users/user devices that can access the network. The owner of the network may, for example only allow users who have a license or are leasing from a licensed operator to access the network. In some implementations, a private 5G network may specify and/or allocate the resources which a user may have access to. This may be performed on a per-user basis, and allows the owner to control parameters such as network performance, capacity, security, and speed.

### SUMMARY

Private 5G network systems in the related art may struggle to address the high data rates, ultra-low latency, and high device density and network slicing for specific service requirements. In particular, for specific service needs, it is necessary to have an effective utilization of network service to meet the service demands. The network architecture for a PvT 5G network architecture needs to have capability and flexibility to be managed for a given service requirement on a per-service basis.

Accordingly, there is a need for a way to manage service requirements and profiles on a per cell group basis.

According to example embodiments, a method may include receiving, by an Access and Mobility Management Function (AMF), a message from a user equipment (UE) including a request for service access; generating, by the AMF based on the request, a service set definition comprising a service set cell group; and forwarding, by the AMF, the service set definition to a Session Management Function (SMF).

Based on the above example embodiments, managing the network will provide additional benefits in end to end (E2E) service management and the network resource management for required services. Further, it may allow for managing and deploying the network for specific services with guaranteed quality of service requirements, smooth access and mobility within specified area, enhanced access control, enhanced service delivery, and enhanced QoS management.

According to example embodiments, an apparatus may be provided, the apparatus including an Access and Mobility Management Function (AMF) configured to: receive a message from a user equipment (UE) comprising a request for service access; generate, based on the request, a service set definition comprising a service set cell group; and forward the service set definition to a Session Management Function (SMF).

According to example embodiments, a non-transitory computer-readable recording medium having recorded thereon instructions executable to perform a method may be provided, the method including: receiving, by an Access and Mobility Management Function (AMF), a message from a user equipment (UE) comprising a request for service access; generating, by the AMF based on the request, a service set definition comprising a service set cell group; and forwarding, by the AMF, the service set definition to a Session Management Function (SMF).

Additional aspects will be set forth in part in the description that follows and, in part, will be apparent from the description, or may be realized by practice of the presented embodiments of the disclosure.

### BRIEF DESCRIPTION OF THE DRAWINGS

Features, aspects, and advantages of embodiments of the disclosure will be described below with reference to the accompanying drawings, in which like reference numerals denote like elements, and wherein:

FIG. 1 illustrates a block diagram of an example system architecture including a single service cell group and VPN, according to one or more example embodiments;

FIG. 2 illustrates a block diagram of an example system architecture including two BBU's, according to one or more example embodiments;

FIG. 3 illustrates a block diagram of an example system architecture including two service cell groups, according to one or more example embodiments;

FIG. 4 illustrates a block diagram of an example system architecture including three service cell groups, according to one or more example embodiments;

FIG. 5 illustrates a block diagram of an example service set definition, according to one or more example embodiments;

FIG. 6 illustrates a block diagram of an example method for generating a service set profile based on user accessing the network, according to one or more example embodiments;

FIG. 7 illustrates a block diagram of an example method for generating a service set profile from the perspective of the AMF, according to one or more example embodiments;

FIG. 8 illustrates a block diagram of an example device for implementing one or more example embodiments; and

FIG. 9 illustrates a block diagram of an example environment for implementing one or more example embodiments.

### DETAILED DESCRIPTION

The following detailed description of example embodiments refers to the accompanying drawings. The foregoing disclosure provides illustration and description, but is not intended to be exhaustive or to limit the implementations to the precise forms disclosed. Modifications and variations are possible in light of the above disclosure or may be acquired from practice of the implementations. Further, one or more features or components of one embodiment may be incorporated into or combined with another embodiment (or one or more features of another embodiment). Additionally, the flowchart and description of operations provided below relate to one of the various embodiments. It should be noted that it is possible to make other embodiments that do not exactly match the flowchart and its description. It is understood that in other embodiments one or more operations may be omitted, one or more operations may be added, one or more operations may be performed simultaneously (at least in part).

It will be apparent that systems and/or methods, described herein, may be implemented in different forms of hardware, firmware, or a combination of hardware and software. The actual specialized control hardware or software code used to implement these systems and/or methods is not limited to the described implementations. Thus, the operation and behavior of the systems and/or methods are described herein without reference to specific software code. It is understood that software and hardware may be designed to implement the systems and/or methods based on the description herein.

Even though particular combinations of features are disclosed in the claims and/or in the specification, these combinations are not intended to limit the disclosure of implementations. In fact, many of these features may be combined in ways not specifically recited in the claims and/or disclosed in the specification. Although each dependent claim listed below may directly depend on only one claim, the disclosure of implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]”, “[A] and/or [B]”, or “at least one of [A] or [B]”, are to be understood as including only A, only B, or both A and B.

It shall be noted that, descriptions of example embodiments of the present disclosure may include terms and names defined in one or more standard organizations, such as the 3rd Generation Partnership Project (3GPP) standard organization, the European Telecommunications Standards Institute (ETSI) standard organization, the Open Radio Access Network (O-RAN) Alliance standard organization, and the like.

Example embodiments segregate network resources by defining segregated network groups, which may be referred to as a “service set definition” for a “service set cell group”.

A service set definition may include specific service requirements, and each service set cell group may be connected to a specific service delivery point at the edge of network through virtual Local Access Network (vLAN) connectivity, that is, using a Virtual Private Network (VPN). In this manner, a required Quality of Service (QoS) from the mapped QoS service profile can be applied at each network segment for the sake of required service quality for a particular service.

According to example embodiments, managing the network may provide additional benefits in end to end (E2E) service management and the network resource management for required services. Further, it may allow for managing and deploying the network for specific services with guaranteed quality of service requirements, smooth access and mobility within specified area, enhanced access control, enhanced service delivery, and enhanced QoS management.

It should be appreciated that the Pvt 5G network deployment is a specific use-case of the service set definition, and other implementations in other types of networks may also be possible.

It is contemplated that features, advantages, and significances of example embodiments described hereinabove are merely a portion of the present disclosure, and are not intended to be exhaustive or to limit the scope of the present disclosure. Further descriptions of the features, components, configuration, operations, and implementations of the example embodiments of the present disclosure are provided in the following.

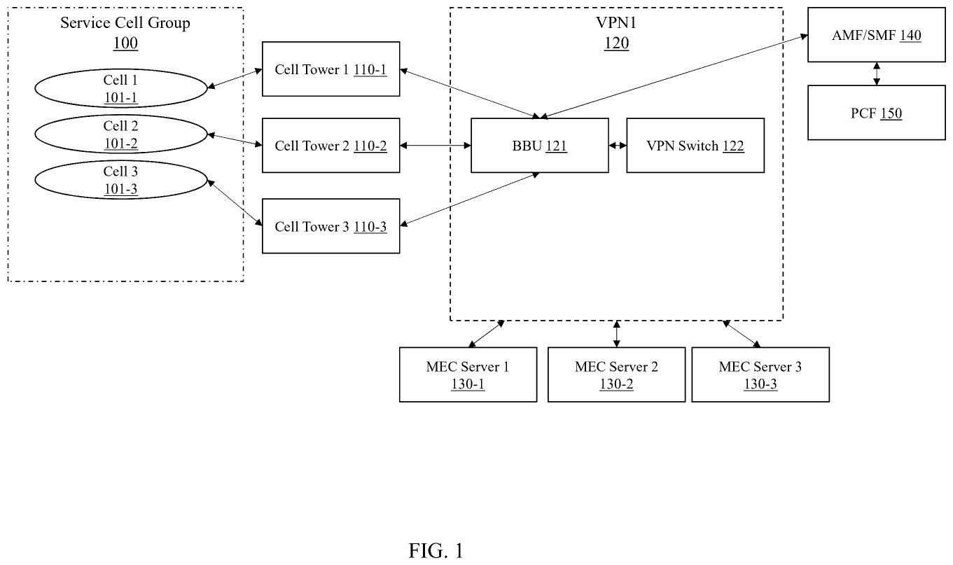

FIG. 1 illustrates a block diagram of an example system architecture including a single service cell group and VPN, according to one or more example embodiments.

Referring to FIG. 1, a service cell group 100 may be provided, including 3 cells, Cell 1 (101-1), Cell 2 (101-2), and Cell 3 (101-3). It should be appreciated that the terms “cell” and user equipment (UE) may be used interchangeably herein. Each of cells 101-1, 101-2, and 101-3 are connected to different cell towers 110-1, 110-2, and 110-3 respectively, although it should be appreciated that according to some implementations, different cells 101 may be connected to the same cell tower. It should be appreciated that the term “cell tower” and base station may be used interchangeably herein.

Virtual Private Network (VPN) VPN1 120 comprises BBU 121 and VPN Switch 122. VPN1 may be interconnected with multiple Multi-access Edge Computing (MEC) servers 130-1, 130-2, and 130-3, via VPN switch 122. A given VPN may be defined by a virtual Local Access Network (vLAN) segregation. BBU 121 may be interconnected with each of the cell towers 110-2, 110-2, and 110-3 in the example implementation. Further, BBU 121 may be interconnected with Access and Mobility Management Function (AMF)/Session Management Function (SMF) 140. AMF/SMF 140 may be interconnected with Policy Control Function (PCF) 150.

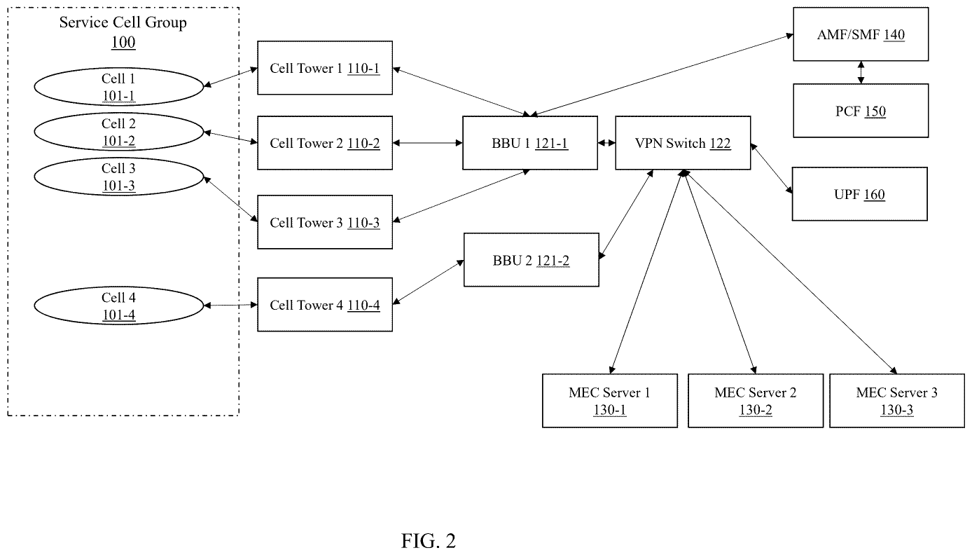

FIG. 2 illustrates a block diagram of an example system architecture including two BBUs, according to one or more example embodiments. The system architecture exemplified in FIG. 2 may share similarities with the example system architecture illustrated in FIG. 1, and accordingly similar descriptions may be omitted to avoid redundancy.

Cell 4 101-4, which belongs to service cell group 100, is introduced in FIG. 2. Cell 4 101-4 may be in communication with a new cell tower, cell tower 4 110-4. Cell tower 4 110-4 may have its own separate baseband unit, BBU 2 121-2, but may connect to the same VPN Switch 122 as with BBU1 121-1. For example, a separate VPN from VPN1 120 illustrated in FIG. 1 above may be defined for Cell 4 over cell group tower 4, 110-4, and one of the MEC servers (e.g., 130-1).

User Plane Function (UPF) 160 may be included in the system architecture, which may be used for packet routing and forwarding, packet inspection, QoS handling, etc.

According to example embodiments, a VPN (e.g., VPN-41) may be defined between VPN switch 122 and UPF 160 (to provide UPF connectivity). VPN-41 may be connected with an edge router for the internet, which is connected to the internet to provide internet connectivity. The UPF 160 in this case may act as an access point for data connectivity to the intranet or internet connectivity.

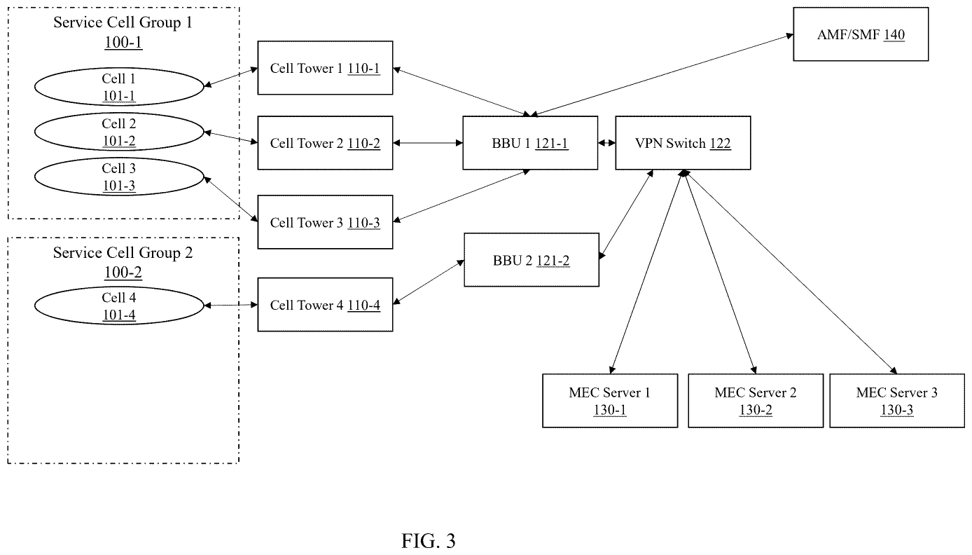

FIG. 3 illustrates a block diagram of an example system architecture including two service cell groups, according to one or more example embodiments.

In particular, two service set cell groups, service cell group 1 100-1 and service cell group 2 100-2 may be defined. Service cell group 1 100-1 includes cell 1 110-1, cell 2 101-2, and cell 2 101-2, whereas service cell group 2 100-2 includes only cell 4 101-4.

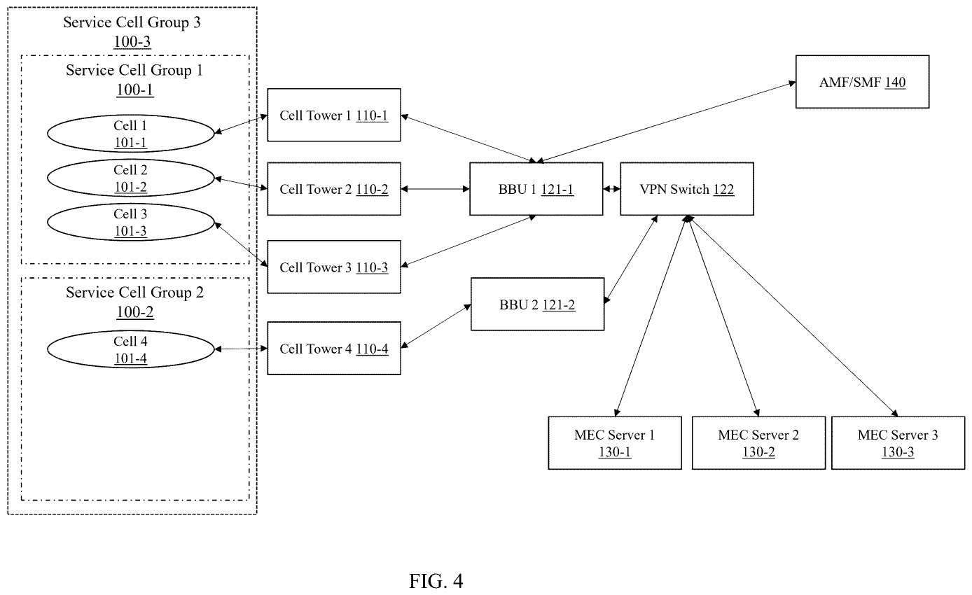

FIG. 4 illustrates a block diagram of an example system architecture including three service cell groups, according to one or more example embodiments.

In particular, a third service set cell group 3 100-3 in addition to FIG. 3 is added, which encapsulates all cells 101-1, 101-2, 101-3, and 101-4. That is, service cell group 100-3 encapsulates both the service cell groups defined by service cell group 1 100-1 and service cell group 2 100-2.

According to example embodiments, each service set cell group 100-1, 101-2, and 101-3 may each be associated with a separate VPN. For example, service set cell group 100-1 may belong to VPN 11, service set cell group 100-2 belongs to VPN 21 (not illustrated in FIG. 4), and service set cell group 100-3 may belong to VPN 31 (not illustrated in FIG. 4). Each of the VPN's may be associated with one of the MEC servers 130 depending on the decision made by the VPN Switch 122 (e.g., either the same or a different MEC server 130 may be used by each VPN, depending on the network load).

According to example embodiments, an example use-case may be provided for an efficient handover scenario. In particular, the network (NW) core nodes may only have a single UE context in the same service set cell group (e.g., 100-1), and no context switching provided during handover. There may be no path switching for the single vLAN defined in this scenario. Accordingly, since no context switching or path switching is required, the handover will be substantially faster as a result of effective resource utilization and low overhead.

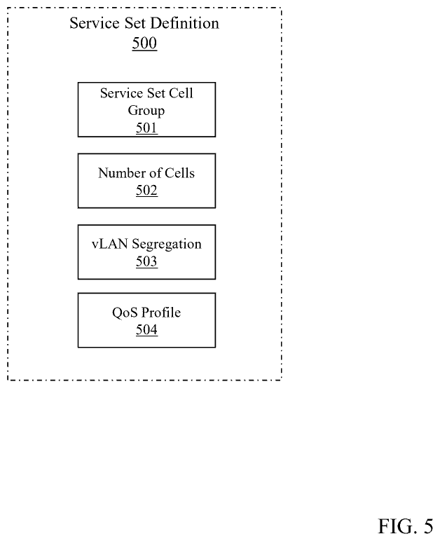

FIG. 5 illustrates a block diagram of an example service set definition 500, according to one or more example embodiments.

The service set definition 500 may include a service set cell group 501, a number of cells 502 in the service cell group, a vLAN segregation 503, and a QoS profile 504.

According to example embodiments, a service set definition 500 may be associated with a particular service set cell group 501. For example, referring to the example system architecture illustrated in FIG. 5, service set cell group 1 100-1 could include cells 101-1, 101-2, 101-3, and thereby have a number of cells 502 of three. This service set cell group 1 could have a vLAN segregation 503 defined as vLAN-1, and QoS profile 504 defined as QoS Profile 1.

Similarly, service set cell group 2 could be defined for service set cell group 2 100-2. This could include only cell 4 101-4, and thereby have a number of cells 502 of one. vLan segregation 503 may be defined as vLAN-2, and QoS profile 504 defined as QoS Profile 2.

As another example, service set cell group 3 could be defined for service set cell group 3 100-3. This could include all the cells 101-1, 101-2, 101-3, and 101-4, and thereby have a number of cells 502 of four. vLAN segregation 502 may be defined as vLAN-3 and QoS profile 504 may be defined as QoS Profile 3.

According to example embodiments, it may be possible to have two or more service set cell groups with the same cells included, but have different parameters. For example, Service set cell group 4 could be associated with the same cells as service set cell group 3, (e.g., 101-1, 102, 101-3, and 101-4) and thereby have a number of cells 502 of four. However, vLAN segregation 502 may be defined as a new vLAN-4 and QoS profile 504 could be defined as a new QoS Profile 4, which have different parameters and/or settings from vLAN-3 and QoS Profile 3 defined previously.

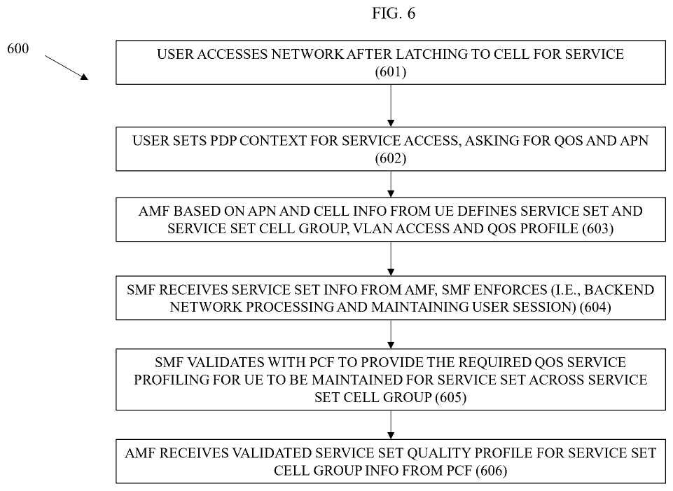

FIG. 6 illustrates a block diagram of an example method 600 for generating a service set profile based on user accessing the network, according to one or more example embodiments.

Referring to FIG. 6, at operation S601, the user may access the network after latching to the cell for service.

At operation S602, the user may set the Packet Data Protocol (PDP) context for service access, asking for a Quality of Service (QoS) profile and Access Point Name (APN) information.

At operation S603, the AMF, based on the APN and cell information from the UE, may define a service set and its associated service set cell group, vLAN access and QoS profile.

At operation S604, the SMF may receive the service set information generated in operation S603, and enforce it (i.e., by performing backend network processing, and maintaining the user session).

At operation S605, the SMF may validate, with a PCF, to provide the required QoS service profiling for the UE to be maintained for the service set across the service set cell group.

At operation S606, the AMF may receive the validated service set quality profile for the service set cell group from the PCF as validated in operation S605.

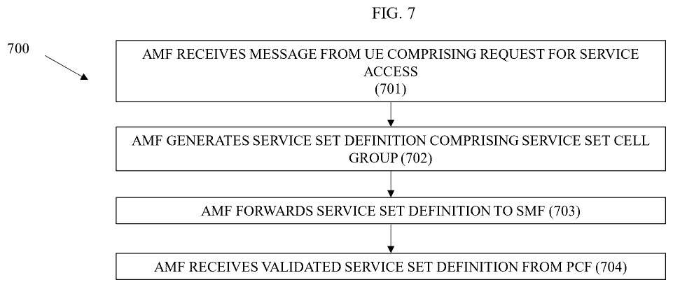

FIG. 7 illustrates a block diagram of an example method 700 for generating a service set profile from the perspective of the AMF, according to one or more example embodiments.

At operation S701, the AMF receives a message from the UE, which may include a request for service access. The request for service access may include a request for a QoS profile and APN (information).

At operation S702, the AMF may generate a service set definition including a service set cell group. The service set definition may include a number of cells (e.g., the number of cells in the service set cell group), a vLAN segregation (which may define a VPN), and the QoS profile.

At operation S703, the AMF may forward the service set definition defined in operation S702 to the SMF. Upon receiving the service set definition, the SMF may enforce the service set definition. According to embodiments, the PCF may be configured to receive the service definition from the SMF to validate the service set definition.

At operation S704, the AMF may receive the validated service set definition from the PCF. According to embodiments, the validated service set definition may include the profiling information for the QoS profile.

Based on the above example embodiments, managing the network will provide additional benefits in end to end (E2E) service management and the network resource management for required services. Further, it may allow for managing and deploying the network for specific services with guaranteed quality of service requirements, smooth access and mobility within specified area, enhanced access control, enhanced service delivery, and enhanced QoS management.

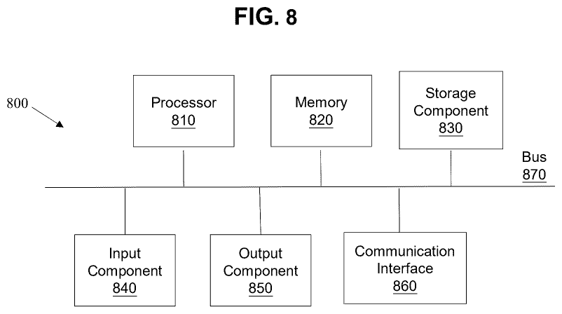

FIG. 8 illustrates a block diagram of an example device 800 for implementing one or more example embodiments. As shown in FIG. 8, the device 800 includes processor 810, a memory 820, a storage component 830, an input component 840, an output component 850, a communication interface 860, and a bus 870.

The processor 810, as used herein, means any type of computational circuit that may comprise hardware elements and software elements. The processor 810 may be embodied as a multi-core processor, a single core processor, or a combination of one or more multi-core processors and/or one or more single core processors, a distributed processing system, or the like. The processor 810 may be a Central Processing Unit (CPU), a graphics processing unit (GPU), an accelerated processing unit (APU), an application-specific integrated circuit (ASIC), or another type of processing component.

Memory 820 includes a non-transitory computer readable medium. Memory 820 includes a random-access memory (RAM), a read only memory (ROM), and/or another type of dynamic or static storage device (e.g., a flash memory, a magnetic memory, and/or an optical memory) that stores information and/or instructions for use by processor 810. The memory 820 comprises machine-readable instructions which are executable by the processor 810. These machine-readable instructions when executed by the processor 810 cause the processor 810 to perform one or more method steps of an embodiment described above.

Storage component 830 stores information and/or software related to the operation and use of the device 800. For example, storage component 830 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium, along with a corresponding drive.

Input component 840 is configured to receive information, such as user input. For example, the input component 840 may include, but not be limited to, a touch screen display, a keyboard, a keypad, a mouse, a button, a switch, and/or a microphone. Additionally, or alternatively, the input component 840 may include a sensor for sensing information (e.g., a global positioning system (GPS), an accelerometer, a gyroscope, and/or an actuator).

Output component 850 is configured to provide output information from the device 800. For example, the output component 850 may be, but not limited to, a display, a speaker, an instruction device to an external device, and/or one or more light-emitting diodes (LEDs).

Communication interface 860 is an interface that provides a communication connection to other devices, such as external devices and internal devices. The connection by the communication interface 860 can be a wired connection, a wireless connection, or a combination of wired and wireless connections, and can be a direct connection or an indirect connection via a communication network that exists between the device 800 and other devices. In other words, the standard of the communication interface 860 is not limited.

The bus 870 acts as an interconnect between the processor 810, the memory 820, the storage component 830, the input component 840, the output component 850, and the communication interface 860 of the device 800. The bus 870 may include a wired interconnection or a wireless interconnection.

The number and arrangement of components shown in FIG. 8 are provided as an example. In practice, device 800 may include additional components, fewer components, different components, or differently arranged components than those shown in FIG. 8. Additionally, or alternatively, a set of components (e.g., one or more components) of device 800 may perform one or more functions described as being performed by another set of components of device 800. Further, one or more method steps described in any of the embodiments may be performed utilizing a plurality of devices 800 in communication with one another.

Example embodiments of the present disclosure may be implemented in any suitable type of environment. In the following, an example environment (in which the example embodiments may be implemented) is described.

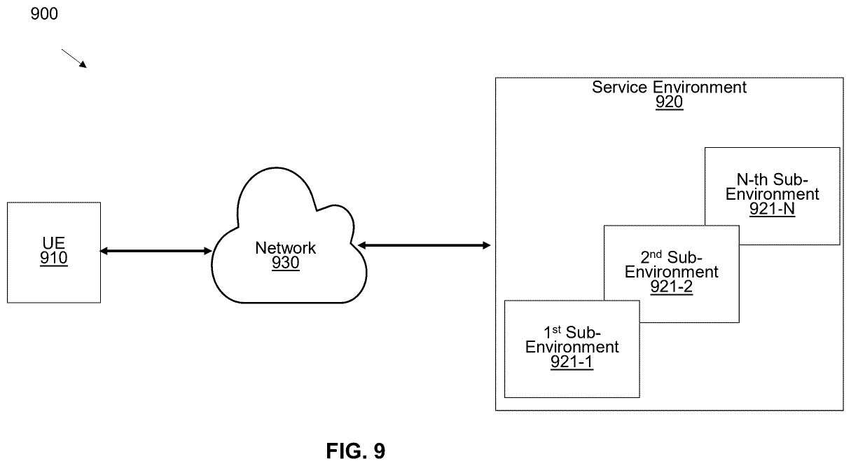

FIG. 9 illustrates a block diagram of an example environment 900 for implementing in which systems and/or method, described herein, may be implemented. The implementation environment 900 includes a UE (User equipment) 910, a service environment 920, and a network 930. The service environment 920 include one or more sub-environments 921. To illustrate this, FIG. 9 shows, for convenience, examples of a 1st sub-environment 921-1, a 2nd sub-environment 921-2, and an N-th sub-environment 921-N (where N is any natural number).

The UE 910 is connected to the network 930, and the network 930 is connected to the service environment 920. The connections may be wired, wireless, or a combination of both wired and wireless. The UE 910 and the service environment 920 are connected via the network 930.

The UE 910 is a device that communicates with the service environment 920. The UE 910 receives information from the service environment 920 and/or sends information to the service environment 920. Also, the UE 910 may generate and/or store information to be transmitted, as necessary. Also, the UE 910 may store and/or process information that is received, as necessary.

The example FIG. 9 refers to the “UE”. However, it should be understood by those skilled in the art that general terms such as “user device,” “terminal,” “terminal device,” “communication device,” and “communication terminal” can be used interchangeably with the term “UE.”

For example, the UE 910 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device.

The service environment 920 is an environment that communicates with the UE 910 to provide one or more services. The service environment 920 receives information from the UE 910 and/or sends information to the UE 910. Also, the service environment 920 may generate and/or store information to be transmitted, as necessary. Also, the service environment 920 may store and/or process information that is received, as necessary. For example, the service environment 920 may provide computing resources as one of the services. It should be noted that the service is not limited to being provided to the UE; it may also be provided to devices other than the UE. For example, based on communication from the UE, the service may perform processes such as anomaly detection or traffic analysis and notify the results to a predetermined destination.

The example FIG. 9 refers to the “service environment”. The term “service environment” is used to refer to the broader context within which services operate. For example, cloud environments, platforms, computing systems, network systems, and cloud systems generally represent the environments in which services are conducted, and these are included within the “service environment.” However, the “service environment” is not limited to these examples. Additionally, the specific types of environments within the “service environment” are not restricted. For instance, cloud environments and cloud systems can be categorized as private cloud, public cloud, hybrid cloud, or multi-cloud, all of which are included within the “service environment.”

The one or more services provided by the service environment 920 is not specifically limited and can be adjusted according to the embodiments. For example, the services may include a service that provides information to the UE 910, a service that stores information from the UE 910, or a service that performs processing based on information from the UE 910 and returns the results of the processing.

In an embodiment, the Service Environments 920 may also provide computing resources as the service. The computing resources can be hardware resources and/or software resources. For example, applications, processors, memory, and storage can be included in the provided computing resources. Each computing resource can communicate with other computing resources via wired connections, wireless connections, or a combination of wired and wireless connections.

The provided computing resources can be actual resources (also referred to as physical resources) and/or virtual resources. Furthermore, means of virtualization for virtual resources can be selected as appropriate. That is, in this disclosure, the use of adjectives such as “Virtual” or “Virtualized” to describe names does not imply that they are virtualized by a specific means of virtualization. For example, “virtual machine” refers to software that operates like an actual computer, realized through means of virtualization, and it is not intended to exclude those realized by specific means of virtualization such as Hypervisors or Containers. Conversely, when means of virtualization such as Hypervisors or containers are mentioned in this disclosure, it is merely cited as a general method of implementation. It should also be interpreted that embodiments implemented with other virtualization means are also disclosed. Also, the services may also be provided using resources virtualized by different means.

The service environment 920 includes one or more devices, such as servers and network devices, which provide services or perform processes. The placement of these devices within the service environment 920 can be determined as appropriate. Additionally, if the service environment 920 includes one or more sub-environments 921, the placement of devices can be determined based on predetermined policies for each sub-environment 921. For example, devices related to the first service may be placed in the 1st sub-environment 921-1, and devices related to the second service may be placed in the 2nd sub-environment 921-2. In another example, devices expected to have a higher load than a predetermined threshold may be placed in the 1st sub-environment 921-1, while devices expected to have a lower load than the predetermined threshold may be placed in the 2nd sub-environment 921-2. In this way, specific devices can be placed in specific sub-environments 921. Conversely, each sub-environment 921 can be specialized for a particular purpose.

In an embodiment, all processes executed in a single service may run within a single service environment, or in multiple service environments. Multiple processes executed in a single service could be provided by different service environments.

The network 930 is a network that exchanges information between the UE 910 and the service environment 920. The network 930 includes one or more wired and/or wireless networks.

For example, the network 930 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, a non-terrestrial network (NTN), and/or a combination of these or other types of networks.

The network 930 can be a part of a network. For example, in a 5G network that includes a RAN, a transport network, and a core network, the network 930 can be at least one of the RAN, the transport network, or the core network. For example, the service environment 920 could be in the core network, in which case the network 930 could correspond to a network that is a combination of a RAN and a transport network and is part of the 5G network.

The number and arrangement of devices and networks shown in FIG. 9 are provided as an example. It should be understood that any changes that may be implemented by those skilled in the art, such as the addition or rearrangement of well-known devices or networks at the time of implementation, are included in this disclosure.

### Various Aspects of Embodiments

It is contemplated that the example embodiments described hereinabove with reference to FIG. 1 to FIG. 9 are merely examples of possible embodiments of the present disclosure, and are not intended to limit or restrict the scope of the present disclosure.

Specifically, the foregoing disclosure provides illustration and description, but is not intended to be exhaustive or to limit the implementations to the precise form disclosed. Modifications and variations are possible in light of the above disclosure or may be acquired from practice of the implementations.

Some embodiments may relate to a device (e.g., node, etc.), a system, a method, and/or a computer-readable medium at any possible technical detail level of integration. Further, one or more of the above components described above may be implemented as instructions stored on a computer-readable medium and executable by at least one processor (and/or may include at least one processor). The computer-readable medium may include a computer-readable non-transitory storage medium (or media) having computer-readable program instructions thereon for causing a processor to carry out operations.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), electrically erasable programmable read-only memory (EEPROM), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer-readable program instructions from the network and forwards the computer-readable program instructions for storage in a computer-readable storage medium within the respective computing/processing device.

Computer-readable program code/instructions for carrying out operations may be assembler instructions, instruction-set-architecture (ISA) instructions, machine instructions, machine-dependent instructions, microcode, firmware instructions, state-setting data, configuration data for integrated circuitry, or either source code or object code written in any combination of one or more programming languages, including an object-oriented programming language such as Smalltalk, C++, or the like, and procedural programming languages, such as the “C” programming language or similar programming languages.

The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects or operations.

These computer-readable program instructions may be provided to a processor of a general-purpose computer, special-purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other devices to cause a series of operational steps to be performed on the computer, other programmable apparatus or other devices to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer-readable media according to various embodiments. In this regard, each block in the flowchart or block diagrams may represent a module, segment, or portion of instructions, which comprises one or more executable instructions for implementing the specified logical function(s). The method, computer system, and computer-readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limited to the implementations. Thus, the operation and behavior of the systems and/or methods were described herein without reference to specific software code—it is understood that software and hardware may be designed to implement the systems and/or methods based on the description herein.

In view of the above, various further respective aspects and features of embodiments of the present disclosure may be defined by the following items:

Item [1]: A method including receiving, by an Access and Mobility Management Function (AMF), a message from a user equipment (UE) including a request for service access; generating, by the AMF based on the request, a service set definition including a service set cell group; and forwarding, by the AMF, the service set definition to a Session Management Function (SMF).

Item [2]: The method according to Item [1], wherein the request for service access includes a request for a Quality of Service (QoS) profile and Access Point Name (APN).

Item [3]: The method according to Item [2], wherein the service set definition includes a number of cells, a virtual LAN (vLAN) segregation, and the QoS profile.

Item [4]: The method according to any one of Items [2]-[3], wherein the SMF is configured to enforce the service set definition.

Item [5]: The method according to Item [4], wherein a Policy Control Function (PCF) is configured to receive the service set definition from the SMF to validate the service set definition.

Item [6]: The method according to Item [5], the method further including: receiving, by the AMF, a validated service set definition from the PCF.

Item [7]: The method according to Item [6], wherein the validated service set definition includes profiling information for the QoS profile.

Item [8]: An apparatus including an Access and Mobility Management Function (AMF) configured to: receive a message from a user equipment (UE) including a request for service access; generate, based on the request, a service set definition including a service set cell group; and forward the service set definition to a Session Management Function (SMF).

Item [9]: The apparatus according to Item [8], wherein the request for service access includes a request for a Quality of Service (QoS) profile and Access Point Name (APN).

Item [10]: The apparatus according to Item [9], wherein the service set definition includes a number of cells, a virtual LAN (vLAN) segregation, and the QoS profile.

Item [11]: The apparatus according to any one of Items [9]-[10], wherein the SMF is configured to enforce the service set definition.

Item [12]: The apparatus according to Item [11], wherein a Policy Control Function (PCF) is configured to receive the service set definition from the SMF to validate the service set definition.

Item [13]: The apparatus according to Item [12], further configured to: receive a validated service set definition from the PCF.

Item [14]: The apparatus according to Item [13], wherein the validated service set definition includes profiling information for the QoS profile.

Item [15]: A non-transitory computer-readable recording medium having recorded thereon instructions executable to perform a method including: receiving, by an Access and Mobility Management Function (AMF), a message from a user equipment (UE) including a request for service access; generating, by the AMF based on the request, a service set definition including a service set cell group; and forwarding, by the AMF, the service set definition to a Session Management Function (SMF).

Item [16]: The non-transitory computer-readable recording medium according to Item [15], wherein the request for service access includes a request for a Quality of Service (QoS) profile and Access Point Name (APN).

Item [17]: The non-transitory computer-readable recording medium according to Item [16], wherein the service set definition includes a number of cells, a virtual LAN (vLAN) segregation, and the QoS profile.

Item [18]: The non-transitory computer-readable recording medium according to any one of Items [16]-[17], wherein the SMF is configured to enforce the service set definition.

Item [19]: The non-transitory computer-readable recording medium according to Item [18], wherein a Policy Control Function (PCF) is configured to receive the service set definition from the SMF to validate the service set definition.

Item [20]: The non-transitory computer-readable recording medium according to Item [19], the method further including: receiving, by the AMF, a validated service set definition from the PCF, wherein the validated service set definition includes profiling information for the QoS profile.

It will be apparent that within the scope of the appended clauses, the present disclosures may be practiced otherwise than as specifically described herein.

What is claimed is:

1. A method comprising
receiving, by an Access and Mobility Management Function (AMF), a message from a user equipment (UE) comprising a request for service access;
generating, by the AMF based on the request, a service set definition comprising a service set cell group; and
forwarding, by the AMF, the service set definition to a Session Management Function (SMF).

2. The method as claimed in claim 1, wherein the request for service access comprises a request for a Quality of Service (QoS) profile and Access Point Name (APN).

3. The method as claimed in claim 2, wherein the service set definition comprises a number of cells, a virtual LAN (vLAN) segregation, and the QoS profile.

4. The method as claimed in claim 2, wherein the SMF is configured to enforce the service set definition.

5. The method as claimed in claim 4, wherein a Policy Control Function (PCF) is configured to receive the service set definition from the SMF to validate the service set definition.

6. The method as claimed in claim 5, the method further comprising:
receiving, by the AMF, a validated service set definition from the PCF.

7. The method as claimed in claim 6, wherein the validated service set definition comprises profiling information for the QoS profile.

8. An apparatus comprising an Access and Mobility Management Function (AMF) configured to:
receive a message from a user equipment (UE) comprising a request for service access;
generate, based on the request, a service set definition comprising a service set cell group;
and forward the service set definition to a Session Management Function (SMF).

9. The apparatus as claimed in claim 8, wherein the request for service access comprises a request for a Quality of Service (QoS) profile and Access Point Name (APN).

10. The apparatus as claimed in claim 9, wherein the service set definition comprises a number of cells, a virtual LAN (vLAN) segregation, and the QoS profile.

11. The apparatus as claimed in claim 9, wherein the SMF is configured to enforce the service set definition.

12. The apparatus as claimed in claim 11, wherein a Policy Control Function (PCF) is configured to receive the service set definition from the SMF to validate the service set definition.

13. The apparatus as claimed in claim 12, further configured to:
receive a validated service set definition from the PCF.

14. The apparatus as claimed in claim 13, wherein the validated service set definition comprises profiling information for the QoS profile.

15. A non-transitory computer-readable recording medium having recorded thereon instructions executable to perform a method comprising:
receiving, by an Access and Mobility Management Function (AMF), a message from a user equipment (UE) comprising a request for service access;
generating, by the AMF based on the request, a service set definition comprising a service set cell group; and
forwarding, by the AMF, the service set definition to a Session Management Function (SMF).

16. The non-transitory computer-readable recording medium as claimed in claim 15, wherein the request for service access comprises a request for a Quality of Service (QoS) profile and Access Point Name (APN).

17. The non-transitory computer-readable recording medium as claimed in claim 16, wherein the service set definition comprises a number of cells, a virtual LAN (vLAN) segregation, and the QoS profile.

18. The non-transitory computer-readable recording medium as claimed in claim 16, wherein the SMF is configured to enforce the service set definition.

19. The non-transitory computer-readable recording medium as claimed in claim 18, wherein a Policy Control Function (PCF) is configured to receive the service set definition from the SMF to validate the service set definition.

20. The non-transitory computer-readable recording medium as claimed in claim 19, the method further comprising:
receiving, by the AMF, a validated service set definition from the PCF, wherein the validated service set definition comprises profiling information for the QoS profile.
